(19) United States
(12) Patent Application Publication
(10) Pub. No.: US 2012/0126685 A1
(43) Pub. Date: May 24, 2012

(54) LAMP FOR INCANDESCENT-LIKE COLOR QUALITY

(76) Inventors: Katalin TÓTH, Pomaz (HU); Istváná Károly Deme, Budapest (HU)

(21) Appl. No.: 12/952,940

(22) Filed: Nov. 23, 2010

(51) Int. Cl. H01J 1/62

(52) U.S. Cl. 313/487; 313/486

(57) ABSTRACT

A low pressure discharge lamp comprises a phosphor composition configured to provide a total light emission having characteristics within specified parameters, including color point above or substantially on the Planckian locus in the CIE standard chromaticity diagram; CCT of from about 2500 kelvin to about 3600 kelvin; general color rendering index Ra(8) of at least about 80; and special color rendering index R′a(14) of from about 72 to about 87. These novel lamps result in incandescent-like color quality while also having favorable efficacy. Also disclosed are phosphor blends which enable the achievement of such lamps.

### FIELD OF THE INVENTION

The present invention generally relates to low pressure discharge lamps, and in particular some embodiments herein relate to low pressure discharge lamps having total light emission exhibiting an incandescent-like color quality.

### BACKGROUND

There is a continuing demand for general-purpose light sources that have energy efficiency. One kind of light source or lamp that has high efficiency is the low-pressure discharge or fluorescent lamp, which may be employed for general illumination in a variety of configurations, such as in the spiral compact fluorescent lamp (CFL) configuration. However, there is a perception often attendant to fluorescent lighting that it lacks fidelity of color, especially with respect to incandescent light bulbs, to which the public has become accustomed. In view of recent governmental regulations regarding the use of incandescent light sources, it can be expected that demand for light sources having a color quality similar to incandescent sources would increase.

Yet, the development of light sources that would simultaneously have incandescent-like color quality and the energy efficiency of fluorescent lamps is not straightforward, especially since there does not yet exist a universally accepted metric for incandescent-like color quality.

It may be desirable to provide lamps having improved color rendering properties while satisfying demand for energy efficiency.

### BRIEF SUMMARY OF THE INVENTION

One embodiment of the present invention is directed to a low pressure discharge lamp for incandescent-like color quality. The lamp comprises a light-transmissive envelope, a discharge-sustaining fill gas sealed inside the envelope, and a phosphor composition disposed on at least an inner surface of the envelope and having a light emission when energized. The lamp and phosphor composition are configured to provide a total light emission when energized that: (a) has a color point above or substantially on the Planckian locus in the CIE standard chromaticity diagram; (b) exhibits a correlated color temperature (CCT) of from about 2500 kelvin to about 3600 kelvin; (c) exhibits a general color rendering index Ra(8) of at least about 80; and (d) exhibits a special color rendering index R′a(14) of from about 72 to about 87.

A further embodiment of the present invention is directed to a fluorescent lamp for incandescent-like color quality, the lamp comprising a phosphor layer. The layer comprises a phosphor composition consisting essentially of the following phosphors: europium-activated yttrium oxide red phosphor present in an amount of from about 40 to about 70 wt %; cerium- and terbium-activated green phosphor present in an amount of from 15 to about 25 wt %; and europium-activated strontium aluminate blue phosphor present in an amount of from about 5 to about 24 wt %; and optionally cerium- and manganese-activated metal pentaborate red phosphor present in an amount of up to about 27 wt %.

A yet further embodiment of the present invention is directed to a fluorescent lamp for incandescent-like color quality, the lamp comprising a phosphor layer. The layer comprises a phosphor composition consisting essentially of the following phosphors: europium-activated yttrium oxide red phosphor present in an amount of from about 48 to about 61 wt %; cerium- and terbium-activated green phosphor present in an amount of from about 18 to about 26 wt %; tetravalent manganese-activated red phosphor present in an amount of from about 10 to about 15 wt %; and optionally europium-activated strontium aluminate blue phosphor present in an amount of from 0 to about 7 wt %; and optionally further divalent manganese- and divalent europium-activated blue-green phosphor present in an amount of from 0 to about 8 wt %.

Other features and advantages of this invention will be better appreciated from the following detailed description.

### BRIEF DESCRIPTION OF THE DRAWINGS

Embodiments of the invention will now be described in greater detail with reference to the accompanying Figures.

FIG. 1 shows diagrammatically, and partially in section, a fluorescent lamp according to embodiments of the present disclosure.

FIG. 2 is a graph of special color rendering indices for certain linear fluorescent lamps.

FIG. 3 illustrates the color points (chromaticities) exhibited by a set of exemplary compact fluorescent lamps in accordance with embodiments of the invention.

FIG. 4 is a graph of special color rendering indices for a set of exemplary compact fluorescent lamps in accordance with embodiments of the invention.

FIG. 5 illustrates the color points (chromaticities) exhibited by another set of exemplary compact fluorescent lamps in accordance with embodiments of the invention.

FIG. 6 is a graph of special color rendering indices for another set of exemplary compact fluorescent lamps in accordance with embodiments of the invention.

### DETAILED DESCRIPTION

In accordance with embodiments, the present invention generally relates to low-pressure discharge lamps, such as fluorescent lamps. It is contemplated to be within the scope of the disclosure to make and use the lamps disclosed herein, in a wide variety of types, including mercury fluorescent lamps, low dose mercury, very high output fluorescent, and mercury-free low-pressure fluorescent lamps. The lamp may include electrodes or may be electrodeless. The lamp may be linear, but any size shape or cross section may be used. It may be any of the different types of fluorescent lamps, such as T5, T8, T12, 17 W, 20 W, 25 W, 32 W, 40 W, 54 W, 56 W, 59 W, 70 W, linear, circular, 2D, twin tube, biax, or U-shaped fluorescent lamps. They may be high-efficiency or high-output fluorescent lamps. For example, embodiments of the present invention include lamps that are curvilinear in shape, as well as compact fluorescent lamps as are generally familiar to those having ordinary skill in the art. Generally, the low-pressure discharge lamps will comprise at least one light-transmissive envelope, which can be made of a vitreous (e.g., glass) material and/or ceramic, or any suitable material which allows for the transmission of at least some visible light. These lamps will comprise a fill gas composition capable of sustaining an electric discharge, which is sealed inside the at least one light-transmissive envelope.

Generally, low pressure discharge lamps in accordance with embodiments of the invention will have at least one phosphor composition carried on said light-transmissive envelope, e.g., on an inner surface of said light-transmissive envelope. As is generally well known, phosphor compositions convert the electromagnetic radiation emanating from the discharge into desired wavelengths, usually of lower energy. In embodiments where the lamp has multiple envelopes, the light-transmissive envelope upon which is disposed a phosphor composition may often be an inner envelope.

In order to achieve incandescent-like color quality, lamps in accordance with embodiments of this disclosure should have a total light emission which has metrics within select parameters, as will be described below. The term “total light emission” refers to the combined light emitted from a lamp having one or more light-emitting elements (e.g., individual phosphors). If a lamp contains more than one light emitting element, the combination of the light from all the elements will be an example of what may constitute a total light emission. For example, a lamp may be a fluorescent lamp having a phosphor layer with one or more phosphors, which phosphors are excited to convert ultraviolet light from a low-pressure vapor discharge. In this case, the total light emission is the combined light emitted by the excited phosphors (and any light from the discharge which escapes). Total light emission may also refer to the combined light emitted from a lamp having one or more light-emitting elements as defined above, and further including (e.g., supplemented by) light from other types of elements (e.g., LED and/or OLED).

In accordance with embodiments of the invention, lamps are provided which have a total light emission which may generally have (a) color point above or substantially on the Planckian locus in the CIE standard chromaticity diagram; (b) correlated color temperature (CCT) of from about 2500 kelvin to about 3600 kelvin; (c) general color rendering index Ra(8) of at least about 80; and (d) special color rendering index R′a(14) of from about 72 to about 87.

As would be generally understood by persons having skill in the field, the apparent color of a light source may be described in terms of correlated color temperature (CCT), which is the temperature of a black body that emits radiation of about the same chromaticity as the radiation considered.

The Color Rendering Index (CRI) is a traditional standard for measuring how well the spectral distribution of a light source compares with that of a blackbody source. The method to measure the color rendering index is disclosed in “Method of Measuring and Specifying Colour Rendering Properties of Light Sources, 2nd Edition”, International Commission on Illumination, Publication CIE No. 13.2 (TC-3.2) 1974, the contents of which are hereby incorporated by reference. The differences in value, chroma and hue of the light reflected under the light source to be measured and the light source are obtained and summed, the square root of the sum is taken, multiplied by a constant, and subtracted from 100. This calculation may be performed for 14 different color standards. The color rendering index for each of these standards is designated Ri, where i=1, . . . , 14.

The first eight Color Rendering Indices (namely, Rᵢ where i is 1-8) are combined by a simple averaging to obtain the “general color rendering index”, which is termed herein Ra(8). It is often desirable to provide a lighting source that generates white light having a relatively high CRI value Ra(8), so that objects illuminated by the lighting may appear similar to those illuminated by the appropriate reference light source. Thus, lamps in accordance with the disclosure may have a total light emission exhibiting a general color rendering index Ra(8) of from about 81 to about 91.

These first eight Color Rendering Indices, however, all are at low to medium chromatic saturation. None of the eight reflective samples used in the computation of Ra(8) are highly saturated. Color rendering of saturated colors can be very poor even when rendering of desaturated colors is good, which would result in a high Ra(8) value. Also, employing only Ra(8) as an object color metric suffers from disadvantages, e.g., the red region of the color space is non-uniform.

Thus, embodiments of the present invention also employ further metrics, including what is termed herein as the “special color rendering index”, R′a(14), which is the average of all fourteen of the color rendering indices Ri, where i is 1 through 14 inclusive. Lamps in accordance with the disclosure may have a total light emission exhibiting R′a(14) of from about 72 to about 87.

Furthermore, embodiments of the present invention may further pay special attention to R₉, which is the special color rendering index for deep red. In accordance with certain embodiments, lamps may have a total light emission exhibiting R₉ of greater than about 0, more preferable of from about 10 to about 30. It may also be advantageous to configure the lamp and phosphor composition to provide a total light emission when energized wherein each value of Ri (i=1 to 14) with the exception of R₉ (that is, each of R₁, R₂, . . . R₁₃, R₁₄ etc. other than R₉) are greater than about 40, more preferably greater than about 50, even more preferably greater than about 60.

Selected values of these metrics Ra(8), R′a(14), and Ri may be chosen when designing lamps for applications where color, color fidelity, and cozy atmosphere are important, such as for general indoor illumination.

The color appearance of the combined light output of a lamp can be described by its chromaticity coordinates, which, as would be understood by those skilled in the art, can be calculated from the spectral power distribution according to standard methods. This is specified according to CIE, Method of measuring and specifying color rendering properties of light sources (2nd ed.), Publ. CIE No. 13.2 (TC-3, 2), Bureau Central de la CIE, Paris, 1974. (CIE is the International Commission on Illumination or Commission Internationale d'Eclairage). In certain embodiments, the lamp may exhibit a total light emission having a color point which is not more than about 0.015 above the Planckian locus. In certain embodiments, the lamps may simultaneously exhibit a total light emission having a color point which is simultaneously above or substantially on the Planckian locus in the CIE chromaticity diagram at the CCT of the lamp, and the color point is within an area on a 1931 CIE Chromaticity Diagram defined by a quadrangle having four vertices with the following x,y coordinates:

(0.408, 0.415)
(0.408, 0.388)
(0.469, 0.400)
(0.469, 0.430).

Certain combinations of light emitting elements are capable of attaining the favorable incandescent-like color qualities noted above. In some embodiments, lamps may comprise a phosphor composition comprising (at least): a first red phosphor having a peak emission in the range of from about 590 nm to about 630 nm, the first red phosphor being present in the composition in an amount of from about 40 to about 70 wt %; and a green phosphor having a peak emission in the range of from about 500 nm to about 570 nm, the green phosphor being present in the composition in an amount of from about 15 to about 26 wt %. This does not preclude further phosphors being present in the composition; often, other types (e.g., blue) will be present in the composition, which may be necessary to achieve the desired color quality. However, as a general matter, lamps in accordance with the invention may comprise at least these first two types (first red and green) of phosphors in the named amounts.

Suitable first red phosphors may have a narrowband peak emission, with a peak emission half-value width which may be generally of from about 1 to about 30 nm. Some suitable first red phosphors may have a peak emission in the range of from about 600 to about 620 nm. In some specific embodiments, the first red phosphor may have a peak emission at about 611 nm and a half-value width of about 2 nm. Concretely, one suitable first red phosphor may comprise an europium-doped yttrium oxide, often where the europium is trivalent. As used herein throughout this disclosure, the term “doped” is equivalent to the term “activated”. A possible formula for the europium-doped yttrium oxide phosphor may be generally (Y₍₁₋ₓ₎Euₓ)₂O₃, where 0<x<0.1, possibly, 0.02<x<0.07, for example, x=0.06. Such europium-doped yttrium oxide phosphors are often abbreviated YEO (or sometimes YOX or YOE). Other possible first red phosphors may include one or more of Strontium red (Sr,Mg)₃(PO₄)₂:Sn; and yttrium vanadate-phosphate (Y(V,P)O₄:Eu); or the like.

Suitable green phosphors may exhibit a narrowband peak emission, with a peak emission half-value width which may be generally from about 1 to about 30 nm. Some suitable green phosphors may have a peak emission in the range of from about 520 nm to about 560 nm, or in the range of from about 535 nm to about 555 nm. One particular suitable phosphor is considered to have a peak emission of about 544 nm and a half-value width of about 5 nm. Often, the green phosphor may be a cerium- and terbium-doped phosphor, such as a cerium- and terbium-doped lanthanum phosphate. Typical formulae for cerium- and terbium-doped lanthanum phosphate may include one selected from LaPO₄:La,Tb; LaPO₄:La³⁺,Tb³⁺; or (La,Ce,Tb)PO₄. Specific cerium- and terbium-doped lanthanum phosphate phosphors in accordance with embodiments of the invention may have the formula (La_{(1-x-y)}CeₓTb_{y})PO₄, where 0.1<x<0.6 and 0<y<0.25 (or possibly, 0.2<x<0.4; 0.1<y<0.2) (LAP). Other possible green phosphors may comprise one or more of ZnSiO₄:Mn; (Ce,Tb)MgAl₁₁O₁₉ (CAT); and (Ce,Tb)(Mg,Mn)Al₁₁O₁₉; or the like.

In a first specific embodiment, lamps may include a phosphor composition comprising the first red phosphor in an amount of from about 40 to about 70 wt %; the green phosphor in an amount of from about 15 to about 25 wt %; and further a blue phosphor having a peak emission in the range of from about 450 to about 500 nm, the blue phosphor present in the composition in an amount of from about 5 to about 24 wt %; and optionally a second red phosphor having a peak emission in the range of from about 600 nm to about 660 nm, the second red phosphor present in the composition in an amount of from 0 to about 27 wt %.

Suitable blue phosphors for this more specific case may have a broadband peak emission, with a peak emission half-value width which may be generally from about 30 to about 100 nm. In embodiments, some suitable blue phosphors may have a peak emission in the range of from about 480 nm to about 500 nm, for example, a peak emission of about 490 nm to about 495 nm and a half-value width of from about 55 to about 75 nm. In certain embodiments, the blue phosphor may comprise a europium-doped phosphor, e.g., a europium-doped strontium aluminate. Such europium-doped strontium aluminate may have the formula of Sr₄Al₁₄O₂₅:Eu²⁺ (SAE). In such formula, the europium-doped strontium aluminate phosphor may comprise Sr and Eu in the following atom ratio: Sr_{0.90-0.99}EU_{0.01-0.1}. Other possible blue phosphors may comprise one or more of (Ba,Sr,Ca)MgAl₁₀O₁₇:Eu²⁺ (BAM); (Sr,Ba,Ca)₅(PO₄)₃Cl:Eu; Y₃Al₅O₁₂:Ce; Ca₁₀(PO₄)₆FCl:Sb,Mn; Sr₆BP₅O₂₀:Eu²⁺; or the like. The optional second red phosphor may have a broadband peak emission, typically with a peak emission half-value width which may be generally from about 30 to about 100 nm. In some embodiments, the second red phosphor may exhibit a peak emission in the range of from about 600 to about 660 nm, e.g., peak emission of about 630 nm with a half-value width of from about 75 to about 80 nm. In embodiments, the second red phosphor may comprise a phosphor doped with at least one of cerium and manganese, e.g., a metal pentaborate doped with at least one of cerium and manganese. Such a metal pentaborate doped with at least one of cerium and manganese can have formula (Gd(Zn,Mg)B₅O₁₀:Ce³⁺,Mn²⁺ (CBM).

In a second specific embodiment, lamps may include a phosphor composition comprising the first red phosphor being present in an amount of from about 48 wt % to about 61 wt %; the green phosphor present in an amount of from about 18 wt % to about 26 wt %; a second red phosphor having a peak emission in the range of from about 620 nm to about 670 nm, present in the composition in an amount of from about 10 wt % to about 15 wt %; and optionally one or more of (i) a blue phosphor having a peak emission in the range of from about 450 nm to about 500 nm present in the composition in an amount of from 0 wt % to about 7 wt %, and (ii) a blue-green phosphor having a peak emission in the range of from about 475 nm to about 525 nm present in the composition in an amount of from 0 wt % to about 8 wt %.

In this second specific embodiment, the second red phosphor may also be characterized as having a peak emission in the range of from about 640 nm to about 660 nm. This second red phosphor may be manganese activated, preferably tetravalent manganese activated, such as a tetravalent manganese-activate fluoromagnesium germanate. One suitable second red phosphor may be 3.5MgO*0.5MgF₂*GeO₂:Mn⁴⁺ (MFG).

In this second specific embodiment, the blue phosphor may be the same as any of blue phosphors already previously noted as having a peak emission in the range of from about 450 to about 500 nm, such as SAE. The blue-green phosphor having a peak emission in the range of from about 475 nm to about 525 nm, may be activated with one of more of manganese (preferably divalent) and europium (preferably divalent), usually both divalent manganese and divalent europium. This peak emission does not preclude the possibility of other lesser emission peaks. One suitable blue-green phosphor may comprise an alkaline earth aluminate, such as (Ba,Sr,Ca)MgAl₁₀O₁₇:Eu²⁺,Mn²⁺ (BAMn). The BAMn phosphor has a first, lesser, emission at about 450 nm due to the Eu^{2+ activator/sensitizer on an “A” lattice site and a second, primary emission at about} 515 nm due to the Mn²⁺ activator on the Mg lattice site. The strength of each peak depends on the concentration of the particular activator in the phosphor. As would be understood by those skilled in the art, a predetermined balance of the concentration of the Eu and Mn may afford the desired blue-green output.

In alternative aspects of the present disclosure, there are provided specific phosphor blends. Each of these may advantageously offer the technical effect of exhibiting the incandescent-like characteristics noted above when employed as a phosphor layer or composition in a low-pressure discharge lamp. A first phosphor blend may consist essentially of (or consist of) the following phosphors: about 40 to about 70 wt % YEO; about 15 to about 25 wt % LAP; about 5 to about 24 wt % SAE; and optionally CBM in amount up to about 27 wt %; all weight percents based on total weight of the phosphor blend. In some embodiments, this first phosphor blend consists essentially of the following three phosphors: YEO, LAP and SAE. In some embodiments, this first phosphor blend consists essentially of the following four phosphors: YEO, LAP, SAE and CBM. The above-noted weight percents for the first phosphor blend carry over to these three- and four-phosphor embodiments.

A second phosphor blend may consist essentially of (or consist of) the following phosphors: about 48 to about 61 wt % YEO; about 18 to about 26 wt % LAP; about 10 to about 15 wt % MFG; and optionally up to about 7 wt % SAE and optionally further up to about 8 wt % BAMn. In some embodiments, this second phosphor blend consists essentially of the following four phosphors: YEO, LAP, MFG and SAE. In some embodiments, this second phosphor blend consists essentially of the following four phosphors: YEO, LAP, MFG, BAMn. Lamps and phosphor blends comprising MFG as described here may especially be suitable for high R₉ values.

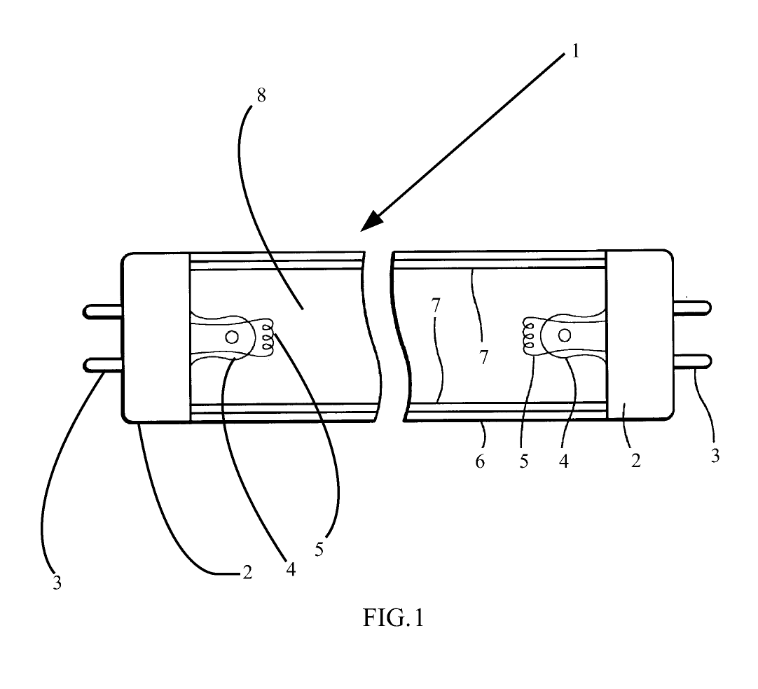

Referring now to FIG. 1, herein is shown an exemplary embodiment of a linear low-pressure vapor discharge fluorescent lamp 1. It will be appreciated that a variety of fluorescent lamps may be used with the present invention, including single or double ended lamps, curved or straight lamps, and electrodeless lamps. Such lamp may contain mercury vapor as a fill, or may be mercury-free, but will (in this exemplary embodiment) contain a vapor (or fill) that supports a discharge. The fluorescent lamp 1 has a light-transmissive tube or envelope 6 formed from glass or other suitable material, which may have a circular cross-section. At least an inner surface (not specifically shown) of the glass envelope 6 is provided with a phosphor-containing layer 7. The lamp is typically hermetically sealed by bases 2, attached at ends of the tube, respectively. Usually two spaced electrodes 5 are respectively mounted on the bases 2, and can be supported by stems 4. Often, spaced-apart lead-in wires extend from the one or more stem, and the electrode extending between said lead-in wires may be a coiled metallic filament comprising an emissive composition. The electrodes 5 are typically provided with current by pins 3 which are received in an electric socket. A discharge-sustaining fill 8, which may be formed from mercury and an inert gas, is sealed inside the glass tube.

The inert gas may be typically argon or a mixture of argon and other noble gases at low pressure, which, in combination with a small quantity of mercury, provide the low vapor pressure manner of operation. The fill may comprise an inert gas comprising one or more of Ar and Kr, e.g., about 15% to 85% Kr and about 85% to 15% Ar. The fill pressure may be from about 1 to about 5 mBar, possibly from about 2 to about 3 mBar. Individual phosphor material amounts used in the phosphor composition of the phosphor layer 7 will vary depending upon the desired color spectra and/or color temperature. It is to be understood that one of ordinary skill in the art would appreciate that other phosphor compounds having similar emission spectra may be used in the phosphor compositions described herein. The weight percent of each phosphor composing the phosphor layer 7 may vary depending on the characteristics of the desired light output.

In an alternative embodiment, the lamp of the present disclosure can be a compact fluorescent lamp (CFL) having a folded or wrapped topology so that the overall length of the lamp is much shorter than the unfolded length of the glass tube (not specifically depicted). The varied modes of manufacture of and configurations for linear as well as compact fluorescent lamps are generally known to persons skilled in the field of low pressure discharge lamps.

Within the general parameters outlined above in reference to FIG. 1, the lamps in accordance with embodiments of the invention may be suitably configured (e.g., via adjustment of fill gas parameters) to achieve an efficacy of at least about 57 lumens per watt (LPW), more preferably of from about 61 LPW to about 87 LPW.

The present low-pressure discharge lamps may generally provide a color solution for achieving low-pressure discharge lamps which may exhibit excellent color fidelity, high general CRI, and improved LPW, while providing a perceived “cozy” effect to ordinary users for indoor applications.

In order to promote a further understanding of the invention, the following examples are provided. These examples are illustrative, and should not be construed to be any sort of limitation on the scope of the claimed invention.

### EXAMPLES

### Example 1

### Comparative Example

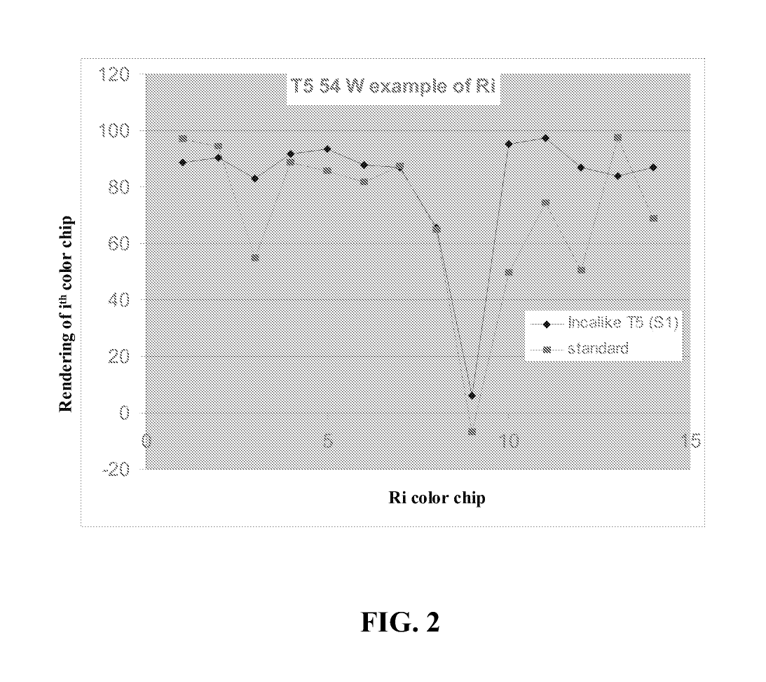

A typical T5 54 W 830 linear fluorescent lamp was constructed so as to be representative of a standard prior art triband (triphosphor) lamp. The phosphor layer was composed of YEO at 60 wt %, LAP at 35 wt %, and BAM at 5 wt %. It exhibited nominal CCT of about 3000 kelvin, a color point above the Planckian locus (at about (0.465, 0.425)). This lamp exhibited Ra(8)=81. However, it rendered saturated red rather poorly (R₉=−7). Importantly, its R′a(14) value was only about 70. Many of its Ri values were below 50. The square boxes in the trace of FIG. 2 illustrates the Ri values for each of the 14 standard colors.

### Example 2

Another linear T5 54 W lamp, denoted S1, was constructed so as to possess incandescent-like color quality. The phosphor blend in S1 was composed of 60.5 wt % YEO, 23.2 wt % LAP, and 16.3 wt % SAE. The fill was 3 mbar of 15% Kr and 85% Ar, so as to attain LPW of about 87. The constructed lamp exhibited Ra(8)=88, color point at about (0.416, 0.398) and above blackbody locus, CCT of about 3250, and importantly R′a(14) of about 82. All Ri values besides R₉ were above 66, and R₉ was about 29. The diamond boxes in the trace of FIG. 2 illustrates the Ri values for each of the 14 standard colors.

### Example 3

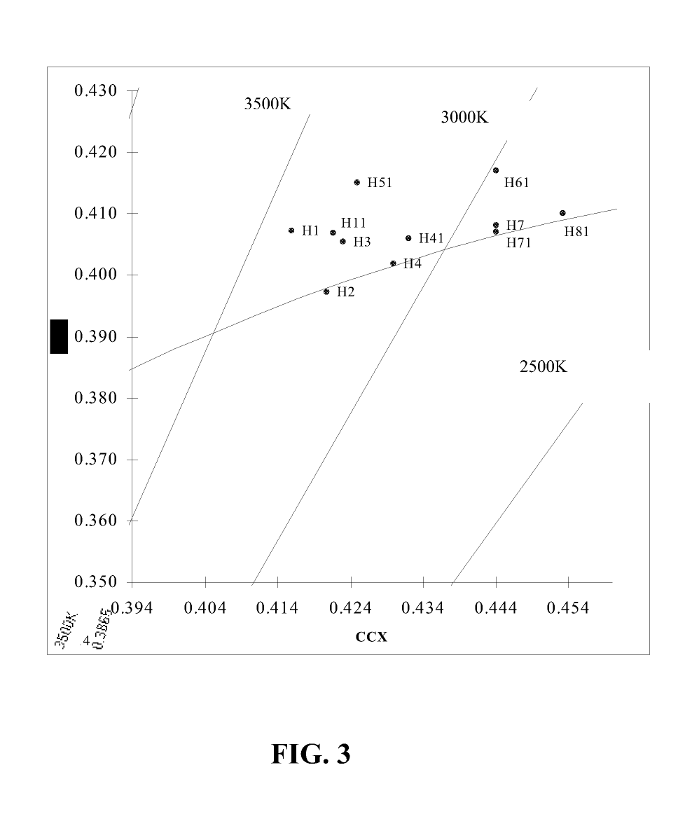

Eleven spiral 20 W CFL fluorescent lamps were constructed in accordance with embodiments of the invention, and denoted the “H” series. Color points are as shown in FIG. 3. Each of these lamps was constructed using the phosphor blend shown in the following table:

| YEO (wt %) | LAP (wt %) | SAE (wt %) | CBM (wt %) |
|---|---|---|---|
| 40-70 | 15-25 | 5-24 | 0-27 |

These lamps in the “H” series exhibited parameters for their total light emission within the ranges shown in the following table:

| | | | Ri values | | |
|---|---|---|---|---|---|
| Lumens/Watt | Ra(8) | R9 | besides R9 | CCT | R′a(14) |
| 57-65 | 81-91 | −2 to 27 | >56 | 2800-3400 | 74-84 |

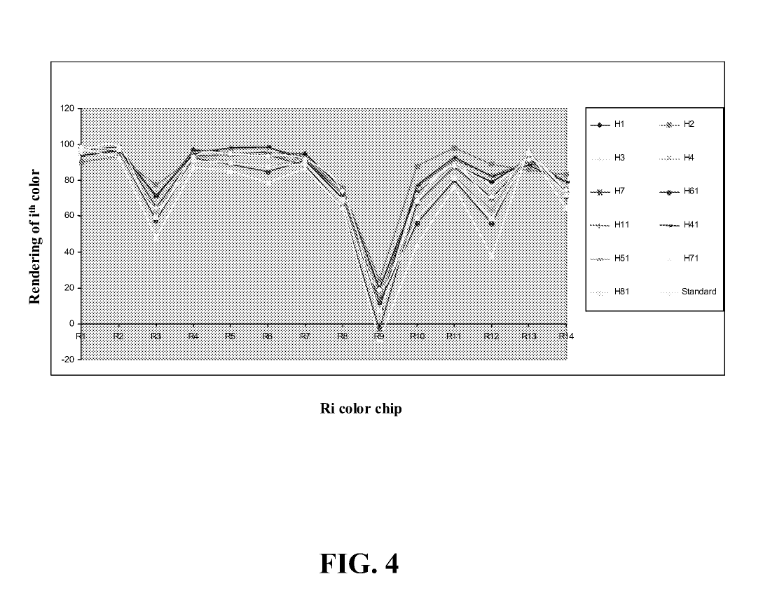

In contrast, a standard CFL of comparable color temperature comprising the phosphor blend of Example 1 merely exhibited R′a(14) of 68, and R₉ of −7, despite an acceptable general color rendering index [Ra(8)] of around 80). FIG. 4 details a trace of the individual special color rendering indices for “H” series CFL examples and the standard 20 W spiral CFL. (See trace with light-yellow triangles).

### Example 4

A yet further set of spiral 20 W CFL mercury vapor fluorescent lamps were assembled employing standard techniques, but with inventive phosphor blends designated as the “E” series. Phosphor compositions for each in the “E” series are shown in the following table:

| | YEO | MFG | LAP | SAE | BAMn |
|---|---|---|---|---|---|
| Code | (wt %) | (wt %) | (wt %) | (wt %) | (wt %) |
| E7 | 59 | 12 | 26 | 3 | 0 |
| E8 | 61 | 13 | 26 | 0 | 0 |
| E9 | 60 | 15 | 25 | 0 | 0 |
| E10 | 60 | 14 | 21 | 0 | 5 |
| E11 | 60 | 14 | 18 | 0 | 8 |

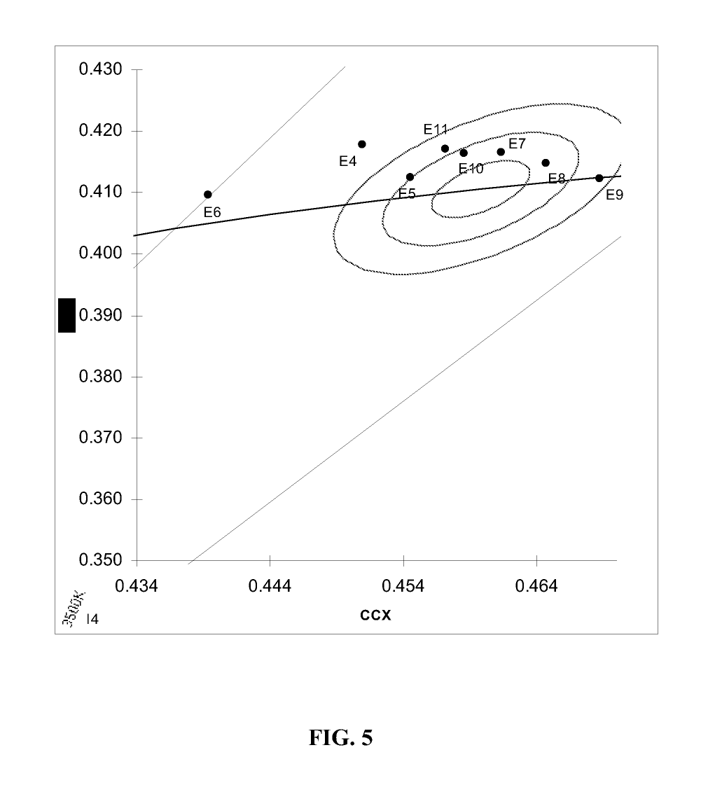

Color points for each lamp in the “E” series are shown in FIG. 5. These lamps exhibited color parameters comparable to the “H” series described above in Example 3, but were more suitable for rendering of the deep red R₉ color chip, presumably by virtue of their content of the deep red phosphor MFG.

### Example 5

Further exemplary compact fluorescent lamps were constructed according to the following table:

| | Design | | LAP | SAE | MFG | CBM |
|---|---|---|---|---|---|---|
| Code | Vehicle | YEO (wt %) | (wt %) | (wt %) | (wt %) | (wt %) |
| “B” | CFL 11W | 59.5 | 28.4 | 0 | 12.1 | 0 |
| “K” | Biax 11W | 53.2 | 23.7 | 16.7 | 0 | 6.4 |
| “KB4” | Biax 11W | 64.9 | 23.8 | 11.3 | 0 | 0 |

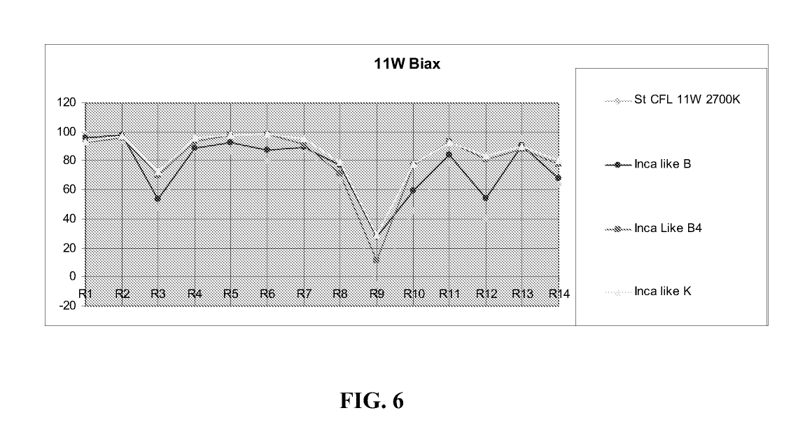

Lamp “B” had the following color parameters: CCT=2607; Ra(8)=85; R₉=29; R′a(14)=76. Lamp “K” manifested the following color parameters: CCT=3513; Ra(8)=91; R₉=30; R′a(14)=84. Lamp “KB4” had the following color parameters: CCT=3076; Ra(8)=89; R₉=10; R′a(14)=81. FIG. 6 details a trace of the individual special color rendering indices for these further exemplary compact lamp examples, vs. a standard 11 W spiral CFL at nominal CCT=2700K. The exemplary lamps are notable for the fact that each value of Ri (i=1 to 14) with the exception of R₉ is above 40.

While examples have been presented utilizing phosphors as light-emitting elements, one of skill can build or adapt a lamp (using any combination light-emitting elements disclosed herein) having the same color rendering properties, by ascertaining the spectral patterns of the lamps made in accordance with these examples. One would choose light emitting elements which match the spectra of the phosphors in the inventive blends described in the examples above.

The above-noted exemplary embodiments provide incandescent-like solutions which are appropriate for general lighting application. The invented light sources practically mimic the effect of a Planckian radiator. They are especially good for applications where color, color fidelity and cozy atmosphere are important, such as in indoor applications.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” used in connection with a quantity is inclusive of the stated value and has the meaning dictated by the context (for example, includes the degree of error associated with the measurement of the particular quantity). “Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present. The singular forms “a”, “an” and “the” include plural referents unless the context clearly dictates otherwise. All ranges disclosed herein are inclusive of the recited endpoint and independently combinable.

As used herein, the phrases “adapted to,” “configured to,” and the like refer to elements that are sized, arranged or manufactured to form a specified structure or to achieve a specified result. While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims. It is also anticipated that advances in science and technology will make equivalents and substitutions possible that are not now contemplated by reason of the imprecision of language and these variations should also be construed where possible to be covered by the appended claims.

What is claimed as new and desired to be protected by Letters Patent of the United States is:

1. A low pressure discharge lamp for incandescent-like color quality, comprising,
a light-transmissive envelope, a discharge-sustaining fill gas sealed inside the envelope, and a phosphor composition disposed on at least an inner surface of the envelope and having a light emission when energized;
wherein the lamp and phosphor composition are configured to provide a total light emission when energized that:
(a) has a color point above or substantially on the Planckian locus in the CIE standard chromaticity diagram;
(b) exhibits a correlated color temperature (CCT) of from about 2500 kelvin to about 3600 kelvin;
(c) exhibits a general color rendering index Ra(8) of at least about 80; and
(d) exhibits a special color rendering index R′a(14) of from about 72 to about 87.

2. The lamp in accordance with claim 1, wherein the phosphor composition comprises,
a first red phosphor having a peak emission in the range of from about 590 nm to about 630 nm, the first red phosphor present in the composition in an amount of from about 40 to about 70 wt %; and
a green phosphor having a peak emission in the range of from about 500 nm to about 570 nm, the green phosphor present in the composition in an amount of from about 15 to about 26 wt %.

3. The lamp in accordance with claim 2, wherein the first red phosphor comprises at least selected from YEO, Strontium red, and yttrium vanadate-phosphate.

4. The lamp in accordance with claim 2, wherein the green phosphor comprises at least one selected from LAP; ZnSiO₄:Mn; (Ce,Tb)MgAl₁₁O₁₉ (CAT); and (Ce,Tb)(Mg,Mn)Al₁₁O₁₉.

5. The lamp in accordance with claim 2, wherein the phosphor composition comprises:
the first red phosphor present in the composition in an amount of from about 40 to about 70 wt %;
the green phosphor present in the composition in an amount of from about 15 to about 25 wt %;
a blue phosphor having a peak emission in the range of from about 450 to about 500 nm, the blue phosphor present in the composition in an amount of from about 5 to about 24 wt %; and
optionally a second red phosphor having a peak emission in the range of from about 600 nm to about 660 nm, the second red phosphor present in the composition in an amount of from 0 to about 27 wt %.

6. The lamp in accordance with claim 5, wherein the blue phosphor comprises at least one selected from SAE; (Ba,Sr,Ca)MgAl₁₀O₁₇:Eu²⁺ (BAM); (Sr,Ba,Ca)₅(PO₄)₃Cl:Eu; Y₃Al₅O₁₂:Ce; Ca₁₀(PO₄)₆FCl:Sb,Mn; and Sr₆BP₅O₂₀:Eu²⁺.

7. The lamp in accordance with claim 5, wherein the second red phosphor comprises CBM.

8. The lamp in accordance with claim 2, wherein the phosphor composition comprises:
the first red phosphor present in the composition in an amount of from about 48 wt % to about 61 wt %;
the green phosphor present in the composition in an amount of from about 18 wt % to about 26 wt %;
a second red phosphor having a peak emission in the range of from about 620 nm to about 670 nm, present in the composition in an amount of from about 10 wt % to about 15 wt %; and
optionally one or more of (i) a blue phosphor having a peak emission in the range of from about 450 nm to about 500 nm present in the composition in an amount of from 0 wt % to about 7 wt %, and (ii) a blue-green phosphor having a peak emission in the range of from about 475 nm to about 525 nm present in the composition in an amount of from 0 wt % to about 8 wt %.

9. The lamp in accordance with claim 8, wherein the second red phosphor comprises MFG.

10. The lamp in accordance with claim 8, wherein the blue phosphor comprises at least one selected from SAE;
(Ba,Sr,Ca)MgAl₁₀O₁₇:Eu²⁺ (BAM); (Sr,Ba,Ca)₅(PO₄)₃Cl:Eu; Y₃Al₅O₁₂:Ce; Ca₁₀(PO₄)₆FCl:Sb,Mn; and Sr₆BP₅O₂₀:Eu²⁺.

11. The lamp in accordance with claim 8, wherein the blue green phosphor comprises BAMn.

12. The lamp in accordance with claim 1, wherein said color point is not more than about 0.015 above the Planckian locus.

13. The lamp accordance with claim 1, wherein the rendering of deep red R₉ is from about 10 to about 30.

14. The lamp accordance with claim 1, wherein said total light emission exhibits all Ri values other than R₉ at greater than about 40.

15. The lamp in accordance with claim 1, wherein the lamp is configured to provide an efficacy of greater than about 57 LPW.

16. The lamp in accordance with claim 1, wherein the total light emission has a color point which is simultaneously above or substantially on the Planckian locus in the CIE chromaticity diagram at the CCT of the lamp, and the color point is within an area on a 1931 CIE Chromaticity Diagram defined by a quadrangle having four vertices with the following x,y coordinates:
(0.408, 0.415)
(0.408, 0.388)
(0.469, 0.400)
(0.469, 0.430).

17. A fluorescent lamp for incandescent-like color quality, the lamp comprising a phosphor layer, the layer comprising a phosphor composition consisting essentially of the following phosphors:
europium-activated yttrium oxide red phosphor present in an amount of from about 40 to about 70 wt %;
cerium- and terbium-activated green phosphor present in an amount of from 15 to about 25 wt %; and
europium-activated strontium aluminate blue phosphor present in an amount of from about 5 to about 24 wt %; and optionally
cerium- and manganese-activated metal pentaborate red phosphor present in an amount of up to about 27 wt %.

18. The lamp of claim 17, wherein the composition consists essentially of the following three phosphors: YEO, LAP and SAE.

19. The lamp of claim 17, wherein the composition consists essentially of the following four phosphors: YEO, LAP, SAE and CBM.

20. A fluorescent lamp for incandescent-like color quality, the lamp comprising a phosphor layer, the layer comprising a phosphor composition consisting essentially of the following phosphors:
europium-activated yttrium oxide red phosphor present in an amount of from about 48 to about 61 wt %;
cerium- and terbium-activated green phosphor present in an amount of from about 18 to about 26 wt %;
tetravalent manganese-activated red phosphor present in an amount of from about 10 to about 15 wt %; and optionally
europium-activated strontium aluminate blue phosphor present in an amount of from 0 to about 7 wt %; and optionally further
divalent manganese- and divalent europium-activated blue-green phosphor present in an amount of from 0 to about 8 wt %.

21. The lamp of claim 20, wherein the composition consists essentially of the following four phosphors: YEO, LAP, MFG and SAE.

22. The lamp of claim 20, wherein the composition consists essentially of the following four phosphors: YEO, LAP, MFG, BAMn.

23. A fluorescent lamp for incandescent-like color quality, the lamp comprising a phosphor layer, the layer comprising a phosphor composition consisting essentially of the following phosphors: YEO, LAP, MFG and SAE.

24. The fluorescent lamp in accordance with claim 23, the LAP present in an amount of from about 18 to about 26 wt %; and the SAE present in an amount of up to about 7 wt %.

25. The fluorescent lamp in accordance with claim 24, the YEO present in an amount of from about 48 to about 61 wt %, and the MFG present in an amount of from about 10 to about 15 wt %.

26. A low pressure discharge lamp for incandescent-like color quality, comprising,
a light-transmissive envelope, a discharge-sustaining fill gas sealed inside the envelope, and a phosphor composition disposed on at least an inner surface of the envelope and having a light emission when energized;
wherein the lamp and phosphor composition are configured to provide a total light emission when energized that:
(a) has a color point above or substantially on the Planckian locus in the CIE standard chromaticity diagram;
(b) exhibits a correlated color temperature (CCT) of from about 2500 kelvin to about 3600 kelvin;
(c) exhibits a general color rendering index Ra(8) of at least about 80; and
(d) exhibits a special color rendering index R′a(14) of from about 72 to about 87;
wherein the phosphor composition consists essentially of the following phosphors: YEO, LAP, MFG and SAE.

27. The low pressure discharge lamp in accordance with claim 26, the LAP present in the composition in an amount of from about 18 to about 26 wt %; and the SAE present in the composition in an amount of up to about 7 wt %.

28. The low pressure discharge lamp in accordance with claim 27, the YEO present in the composition in an amount of from about 48 to about 61 wt %; and the MFG present in the composition in an amount of from about 10 wt % to about 15 wt %.
